(19) United States
(12) Patent Application Publication
(10) Pub. No.: US 2013/0235281 A1
(43) Pub. Date: Sep. 12, 2013

(54) VIDEO DISPLAY SYSTEM

(71) Applicant: Adam DAVIS, Leola, PA (US)

(72) Inventor: Adam DAVIS, Leola, PA (US)

(73) Assignee: TAIT TECHNOLOGIES, INC., Warrdamme (BE)

(21) Appl. No.: 13/543,170

(22) Filed: Jul. 6, 2012

(30) Foreign Application Priority Data
Mar. 9, 2012 (BE) 2012/0157

(51) Int. Cl. H04N 5/64

(52) U.S. Cl. 348/801; 348/839; 348/E05.13

(57) ABSTRACT

A video display system includes an electroacoustic device secured within a housing. A plurality of modules is operatively associated with the housing and is arranged to form a display area, each of the modules including at least one light source. The modules cooperatively display light to display at least one of video and images.

### FIELD OF THE DISCLOSURE

The present disclosure relates to display systems. More specifically, the present disclosure relates to video display systems associated with electroacoustic devices.

### BACKGROUND OF THE DISCLOSURE

Electronic displays for use in advertising are well known in the art. Such electronic displays find use in advertising applications in a variety of environments. In recent years, flat-panel display technologies have been developed, such as plasma, LCD, LED and other types of vertically mounted displays, such as may be used in forming billboards or secured to vertically extending structures or vertically suspended from such structures for use with other public venues.

However, known video displays, particularly for advertising on billboards and similar structures, can be large, requiring large amounts of space and separate electrical requirements.

Therefore, there is an unmet need to provide a display system associated with a public venue and/or a public performance, making at least partial use of already existing components and power/resources. The display system should also improve the effectiveness or quality of the system's use with the public venue and/or public performance.

### SUMMARY OF THE DISCLOSURE

One aspect of the disclosure includes a video display system including an electroacoustic device secured within a housing. A plurality of modules is operatively associated with the housing and is arranged to form a display area, each of the modules including at least one light source. The modules cooperatively display light to display at least one of video and images.

A further aspect of the disclosure includes a method of displaying video. The method further includes providing a video display system including an electroacoustic device secured within a housing, and a plurality of modules associated with the housing and being arranged to form a display area, each of the modules including at least one light source. The method further includes cooperatively displaying light with the modules to display at least one of video and images.

An advantage of the present disclosure is a video display system that at least partially makes use of existing components and power/resources associated with the system.

Another advantage of the present disclosure is a video display system that uses electroacoustic devices secured within a housing to form a video display from modules including at least one light source for cooperatively displaying light to display at least one of video and images, while permitting substantially unobstructed acoustical communication through the housing.

It is to be understood that one or more of the above-referenced advantages may be contained in an exemplary embodiment of the present disclosure.

Further aspects of the method and system are disclosed herein. The features as discussed above, as well as other features and advantages of the present disclosure, will be appreciated and understood by those skilled in the art from the following detailed description and drawings.

### BRIEF DESCRIPTION OF THE DRAWINGS

FIG. 1 shows a perspective view of an exemplary embodiment of a video display system.

FIG. 2 shows an enlarged, partial perspective view of the exemplary embodiment of FIG. 1 of a video display system.

FIG. 3 shows a perspective view of a module of a video display system according to an embodiment.

FIG. 4 shows a perspective view of a module of a video display system according to an alternate embodiment.

FIG. 5 shows a cross section taken along line 5-5 of FIG. 2 of an embodiment of a video display system.

FIG. 6 shows a cross section taken along line 5-5 of FIG. 2 of another embodiment of a video display system.

FIG. 7 shows a perspective view of a further embodiment of a video display system.

FIG. 8 shows an elevation view of another embodiment of a video display system.

FIG. 9 shows a perspective view of a further embodiment of a video display system.

FIG. 10 shows a perspective view of an additional embodiment of a video display system.

FIG. 11 shows a perspective view of a further embodiment of a video display system.

FIG. 12 shows a perspective view of yet an additional embodiment of a video display system.

### DESCRIPTION OF THE DISCLOSURE

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

What is provided are video display systems used with electroacoustic devices having an enclosure or housing, such as loudspeakers or speakers. More specifically what is provided are video display systems being viewably formed inside of or secured to an enclosure or housing of the electroacoustic device. The video display systems are associated with public venues or public performances, for example, sports stadiums, amphitheaters, transportation facilities, shopping malls, and the like, for advertising, entertainment, information or other applications.

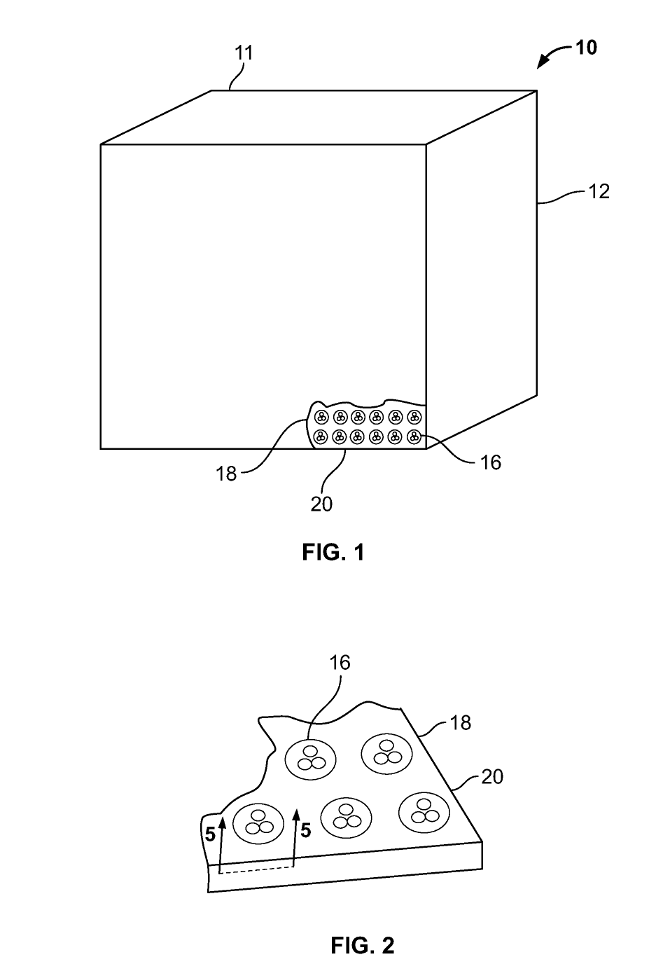

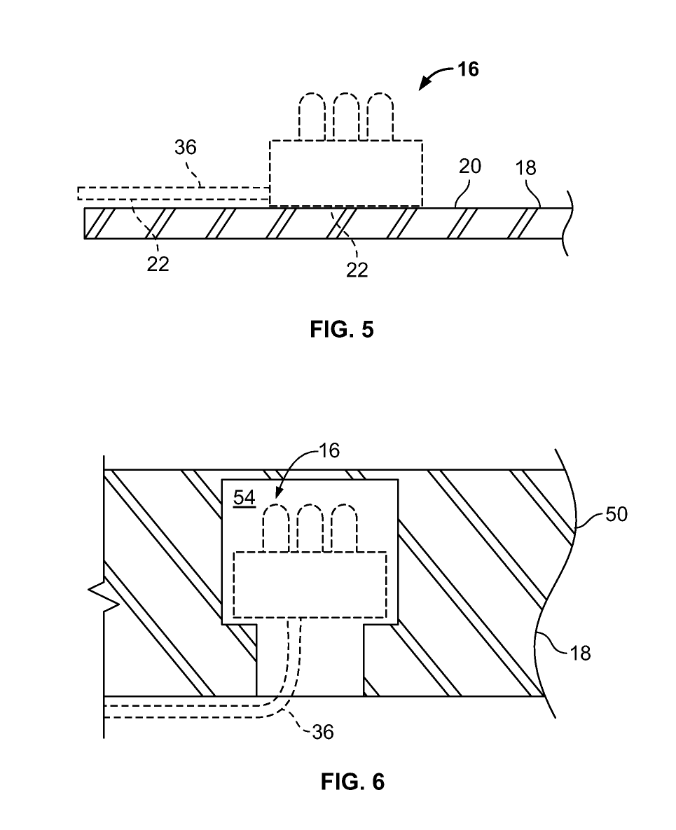

FIG. 1 illustrates one embodiment of a video display system 10. The video display system 10 includes a plurality of modules 16 operatively associated with an electroacoustic device 11 associated with a public venue or performance. Without intending to be limiting, a public venue or performance may include shopping malls, airports or public transportation facilities, athletic performances, cultural performances, entertainment performances and combinations thereof. In other words, a public venue or performance is intended to include any basis for a public gathering. As further shown in FIG. 1, electroacoustic device 11, such as a loudspeaker or speaker, is normally contained within an enclosure or housing 12 and further includes a cover 20 that extends over an opening formed in the housing to direct sound waves from the housing and otherwise generally protect components contained inside of the device. A plurality of modules 16 are arranged together on (FIG. 5) or within (FIG. 6), each of which shows a cross section taken along line 5-5 of FIG. 2, with respective covers 20, 50 to form a display area 18 that may encompass one or more portions of the cover. In one embodiment, display area 18 may substantially coincide in areal size and/or profile or shape with cover 20, 50, although in another embodiment, the display area may be larger in areal size than the cover. That is, with respect to FIG. 1, display area 18 may extend outside of normal confines or edges or borders of the cover 20 of electroacoustic device 11. Modules 16 forming display area 18 may be arranged in a low-resolution or high-resolution video configuration.

It is to be understood that the cover 20 of electroacoustic device 11, which is associated with at least a portion of housing 12, is generally configured to permit substantially unobstructed acoustical communication through the cover. In one embodiment, at least a portion of cover 20 is composed of a suitable resilient material, such as a fabric. However in another embodiment, cover 20 may be composed primarily of a resilient material. In yet another embodiment, cover 20 may be at least partially composed of a substantially rigid material, such as a sheet of perforated metal. In a further embodiment cover 20 may be composed primarily of substantially rigid material. Alternately, in another embodiment (FIG. 6), at least a portion of cover 50 may be composed of a suitable substantially rigid material, such as wood. In another embodiment, cover 50 may be primarily of a suitable substantially rigid material. When the cover 50 is composed of a substantially rigid material that is substantially transparent, module 16 may be received and secured in pockets 54 formed in the cover. Alternately, at least a portion of modules 16 may be secured inside of housing 12 and/or cover 20.

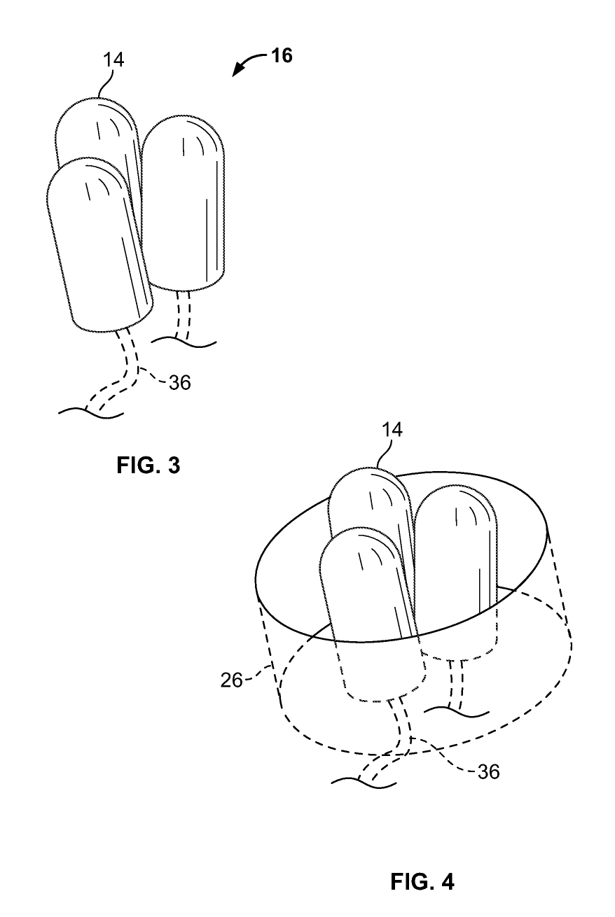

Modules 16 include one or more colored light sources 14 (FIGS. 3-4), such as light emitting diodes (LEDs). In one embodiment, such as further shown in FIG. 3, colored light sources include a grouping of red, green and blue LEDs, although in other embodiments, different numbers and colors of light sources may be used, if desired. The light sources 14 may be controlled by any suitable control means (not shown) known in the art for providing images and/or video. The light sources may include, for example, organic light emitting diodes (OLEDs), incandescent bulbs, fluorescent bulbs, polymer light emitting diodes, electroluminescent lights, other suitable light emitting sources, and/or a combination of light emitting units. Modules 16 may be provided as individual elongate units or may be units of alternate geometries or groupings of units, such as contained in a housing 26 (FIG. 4) that provide the desired visual, video or combined effect. Modules 16 can be individually or collectively secured to cover 20 (FIG. 5), which modules overlying and secured to the cover, such as by a securing member 22, which may include a layer of adhesive or suitable hardware, including clips, brackets, loops, hooks or other suitable arrangements or techniques. Alternately, modules 16 be similarly secured underlying or beneath cover 20 and inside of housing 12, if openings (not shown) are formed in the cover such that modules 16 are viewable through the cover. In yet another embodiment, modules 16 may be secured inside of a substantially transparent cover 50, such as in pockets 54 formed in the cover.

As shown in the figures, modules 16 are preferably in communication with each other and controlled by a single controller or a series of controllers, which coordinate display area 18. Modules 16 may be connected to each other and/or the controller by any suitable means, including, but not limited to, wired connections 36 (FIGS. 3-4) or wireless connections. In one embodiment, video or image information may be transmitted to modules 16 to provide the desired visual display. Video display system 10 may use video signals, image signals, controllers and the control systems known in the art for providing video and/or images to LED systems. It is to be understood that video and images associated with video display system 10 may include text, either by itself or combined with one or more of video and/or images.

The control of modules 16 may be provided by the same controller or may be provided by one or more controllers and may comprise or include a computing device.

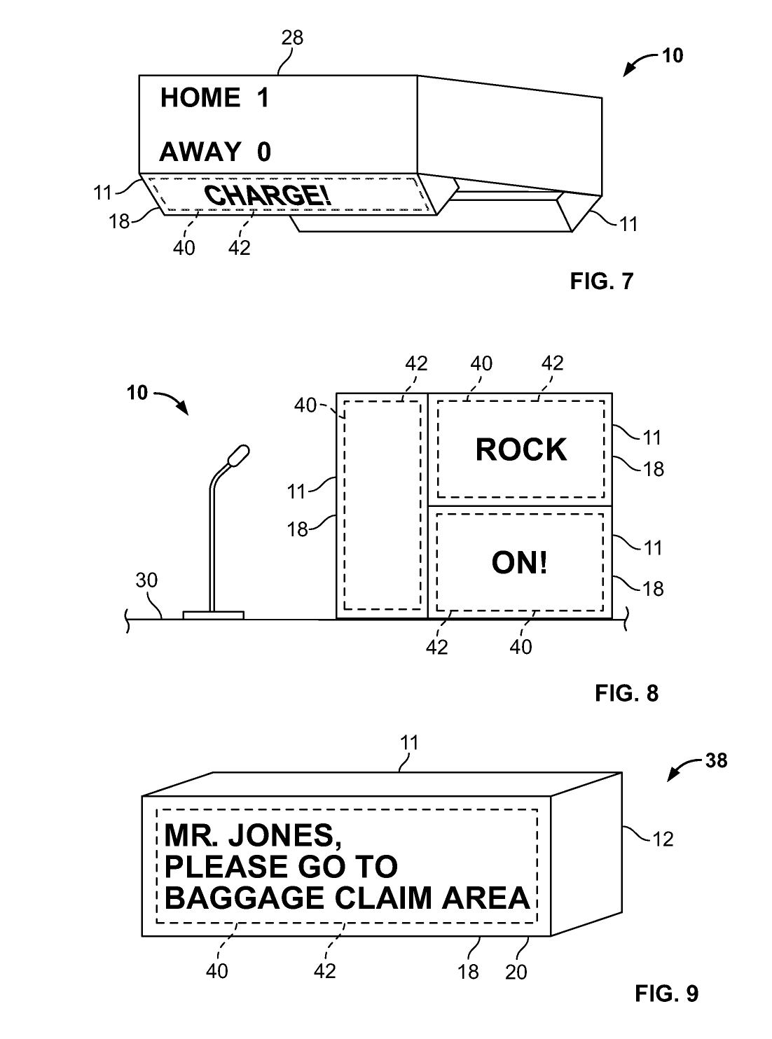

FIGS. 7-12 show exemplary arrangements of modules 16 operatively associated with electroacoustic devices 11 of the display system 10. As shown in FIG. 7, a scoreboard 28 such as associated with a sports stadium or athletic performance, includes electroacoustic device 11 positioned beneath the scoreboard, with display area 18 of the electroacoustic device 11 showing video 40 and/or images 42 of text provided to lead the audience in a chant/cheer. It is to be understood that electroacoustic device 11 can be showing any combination of video 40 and/or images 42, including text, as desired.

As yet further shown in FIG. 8, display system 10 may include an activity area 30, such as for a musical performance. The numerous electroacoustic devices 11 showing the combination of video 40, and/or images 42, including text as shown on display area 18. Video and/or images of display area 18 of one or more electroacoustic devices may overlap into adjacent display areas of adjacent electroacoustic devices, if desired. In other words, one or more video 40 and/or images 42 may have a larger surface area surface area than a surface area of any single electroacoustic device display area, at least partially extending onto one or more display areas of adjacent electroacoustic devices.

As yet further shown in FIG. 9, display system 10 may include a public venue 38, such as an airport. Electroacoustic device 11 can be configured to show a combination of video 40, and/or images 42, including text as shown on display area 18. As further shown in FIG. 9, a text image may correspond to an audio transmission substantially simultaneously occurring, to aid a traveler by providing a visual representation of the audio transmission being broadcast by electroacoustic device 11. This functionality/capability of the system improves the effectiveness or quality of the public venue.

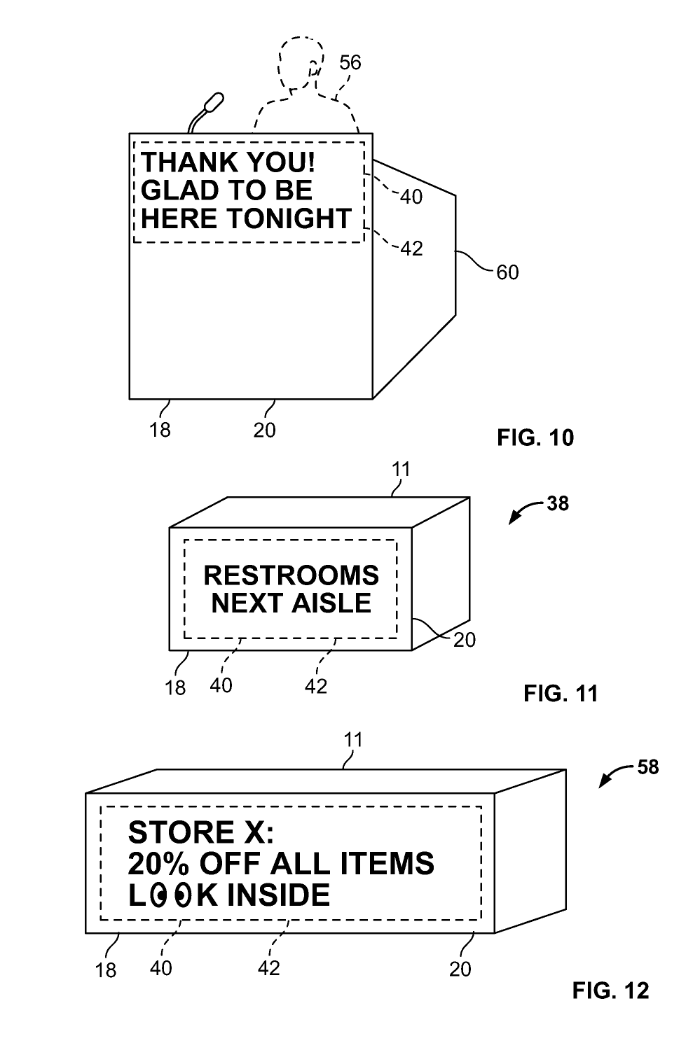

FIG. 10 shows a podium 60 containing electroacoustic device 11 including display area 18 and showing video 40 and/or images 42, including text substantially corresponding in real-time to words spoken by an individual 56 located behind podium 60.

FIG. 11 shows electroacoustic device 11 for use with a public venue 38, such as an amphitheater, in which electroacoustic devices 11 may serve not only to provide audio transmissions broadcast by electroacoustic device 11, such as during a public performance, but may also simultaneously provide video 40 and/or images 42, including text, such as providing information, such as identifying the locations of restrooms or other information.

FIG. 12 shows electroacoustic device 11 for use with a commerce facility 58, such as a shopping mall, in which electroacoustic devices 11 may serve not only to provide audio transmissions broadcast by electroacoustic device 11, such as general information of interest to shoppers, but may also simultaneously provide video 40 and/or images 42, including text, such as identifying locations of stores holding special sales or other information.

In another embodiment, connections 36 of modules 16 may include power and/or signal functionality. For example, connections 36 may be one or more communication and/or power providing cables, such as fiber optic or copper-based wires or cables, or Ethernet cables.

In yet another embodiment, connections 36 may be wires, such as power cords, run alongside cables and connected to a controller (not shown). In one embodiment, the wires and the cables may be integrated. In another embodiment, the wires may be integrated by being circumferentially bounded by cables, providing structural support.

Modules 16 can be one or more light emitting devices. For example, the light emitting devices may be light emitting diodes (LEDs) housed within a housing that may be transparent, translucent, semi-transparent, semi-translucent, or a combination thereof. In one embodiment, the LEDs may be configured to emit colored light based upon a signal from controller (not shown). In another embodiment, the modules 16 may emit a single color of light. In another embodiment, the modules 16 may emit multiple colors of light simultaneously or at different times. In yet another embodiment, multiple LEDs may be housed within the same module 16. In yet another embodiment, with the multiple LEDs housed in the same modules 16, LEDs may be configured to emit multiple colors such that the different colors are mixed within modules 16 thereby permitting additional control of the video or images displayed.

In one embodiment, modules 16 may be powered by individual batteries housed with LEDs or other light sources. In another embodiment, LED can have a battery power source and another LED can use the battery as a power source by having wires carrying power from other LEDs.

Another embodiment includes OLEDs as LEDs. OLEDs may reduce power requirements and permit longer operation on the same charge. OLEDs may permit modules 16 to run on the same charge for a long period of time, for example, by providing power to the OLEDs and then disconnecting the power source from the OLEDs, and then displaying the system.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A video display system comprising:
an electroacoustic device secured within a housing;
a plurality of modules operatively associated with the housing and being arranged to form a display area, each of the modules including at least one light source; and
wherein the modules cooperatively display light to display at least one of video and images.

2. The system of claim 1, wherein the modules include light sources selected from the group consisting of light emitting diodes, organic light emitting diodes, polymer light emitting diodes, electroluminescent lights and combinations thereof.

3. The system of claim 1, wherein at least a portion of a housing associated with the modules includes a cover permitting substantially unobstructed acoustical communication therethrough.

4. The system of claim 3, wherein the cover is composed primarily of a resilient material.

5. The system of claim 3, wherein the cover is composed primarily of a substantially rigid material.

6. The system of claim 3, wherein at least a portion of the cover is composed of a resilient material.

7. The system of claim 3, wherein at least a portion of the cover is composed of a substantially rigid material.

8. The system of claim 7, wherein the substantially rigid material is substantially transparent.

9. The system of claim 3, wherein at least a portion of the modules are secured to the cover.

10. The system of claim 8, wherein at least a portion of the modules are secured inside of the housing.

11. The system of claim 7, wherein at least a portion of the modules are secured inside of the cover.

12. A method of displaying video comprising:
providing a video display system comprising:
an electroacoustic device secured within a housing;
a plurality of modules associated with the housing and being arranged to form a display area, each of the modules including at least one light source; and
cooperatively displaying light with the modules to display at least one of video and images.

13. The method of claim 12, wherein the modules include light sources selected from the group consisting of light emitting diodes, organic light emitting diodes, polymer light emitting diodes, electroluminescent lights and combinations thereof.

14. The method of claim 12, wherein at least a portion of a housing associated with the modules includes a cover permitting substantially unobstructed acoustical communication therethrough.

15. The method of claim 14, wherein the cover is composed primarily of a resilient material.

16. The method of claim 14, wherein the cover is composed primarily of a substantially rigid material.

17. The method of claim 14, wherein at least a portion of the cover is composed of a resilient material.

18. The method of claim 14, wherein at least a portion of the cover is composed of a substantially rigid material.

19. The method of claim 18, wherein the substantially rigid material is substantially transparent.

20. The method of claim 19, wherein at least a portion of the modules are secured to or inside of the cover.
